(19) United States
(12) Patent Application Publication
(10) Pub. No.: US 2019/0139077 A1
(43) Pub. Date: May 9, 2019

(54) PROVIDING REPORTING AND ANALYSIS FOR CAMPAIGN-DRIVEN MESSAGES AND WEBSITES

(71) Applicant: OBSERVEPOINT, INC., Provo, UT (US)

(72) Inventors: Matthew McKay Thomas, American Fork, UT (US); Kenneth W. Holladay, American Fork, UT (US)

(21) Appl. No.: 15/966,826

(22) Filed: Apr. 30, 2018

Related U.S. Application Data
(60) Provisional application No. 62/581,435, filed on Nov. 3, 2017.

(51) Int. Cl. G06Q 30/02; G06F 9/455; H04L 12/58

(52) U.S. Cl. CPC G06Q 30/0242; G06Q 30/0269; G06F 2009/45595; H04L 51/04; G06F 9/45558

(57) ABSTRACT

Embodiments are directed to reporting on content generated as part of a campaign. A computer system generates a targeted digital message in response to receiving a user dataset. An audit system then audits the targeted digital message to determine whether it matches a message template.

### CROSS-REFERENCE TO RELATED APPLICATIONS

This application claims priority to and the benefit of U.S. Provisional Application Ser. No. 62/581,435 entitled “PROVIDING REPORTING AND ANALYSIS FOR CAMPAIGN-DRIVEN MESSAGES AND WEBSITES”, filed on Nov. 3, 2017, the entire contents of which is incorporated by reference herein in its entirety.

### BACKGROUND

Targeted advertising has long been an ideal method of marketing. In contrast to general marketing that is broadly communicated to the public, targeted advertising attempts to identify particular people with particular interests and then send those particular people advertisements that align with those interests. One will appreciate that such targeted advertising is more efficient and more welcome by the receiver than broadly communicated general marketing.

While targeted advertising has long been a desired outcome for marketing companies, historically it was only achievable in broad sweeping generalizations. For example, automobile manufacturers often attempt to advertise new truck models during football games. The automobile manufacturers hope that the demographic of people who watch football games aligns with the demographic of people who would likely buy a new truck. One will also appreciate, however, that in many cases conventional methods of advertising are either wasted because the receiving audience is outside the desired demographic or wasted because the advertising fails to reach other individuals who are within the desired demographic.

In recent years, the arrival of the internet and its associated media platforms have significantly impacted the ability of marketing companies to target their advertisements. Using conventional tracking tools, marketing companies are now able to track an individual's browsing habits and identify particular advertisements that may be of interest to that user. Further, marketing companies are able to personalize the advertisements on a per user basis.

While this infusion of technology into marketing has significantly benefited the marketing field, it has also generated new and novel technological problems that are particular to the internet. For example, internet marketing is now heavily automated and dynamic making it is difficult to properly audit these marketing systems to ensure that they are functioning according to specifications. This is further complicated by technological distinctions within marketing. For example, a marketing company may automatically detect the type of computing device that a person is using and then send an advertisement that is specially crafted for display on that particular type of computing device. As such, it is not only beneficial to determine that the correct advertisement is being sent, it is also beneficial to determine that the marketing system correctly identified the user's computing device and correctly provided an advertisement that is designed for the identified device.

One will appreciate that a technological problem in any of these steps can have a dramatic impact on the performance of internet-unique advertising. As such, there are several ways in which the art can be improved.

### BRIEF SUMMARY

Embodiments described herein are directed to a computer system for auditing a targeted digital messaging system. The computer system initiates a network-connected hypervisor that is executing a particular-computer environment. The network-connected hypervisor is in digital communication with a targeted digital messaging system that is located external to the hypervisor. The particular-computer environment is storing a digital persona dataset.

The computer system also communicates from the network-connected hypervisor to the targeted digital messaging system a first user dataset that is selected from the digital persona dataset. The first user dataset comprises one or more variables associated with a particular class of users. In response to the targeted digital messaging system receiving the one or more variables, the computer system receives a targeted digital message. The computer system then renders, within the particular-computer environment, the targeted digital message generated by the targeted digital messaging system.

Rendering the targeted digital message comprises rendering message attributes that are responsive to the one or more variables within the first user dataset. The computer system then audits the message attributes against a message template. The computer system also generates a report indicating at least a portion of the differences between the message attributes and the message template.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates an embodiment of a computer system for auditing digital targeted messages.

FIG. 2 illustrates another embodiment of a computer system for auditing digital targeted messages.

FIG. 3 illustrates an embodiment of a computer system for auditing digital targeted messages interacting with a user interface.

FIG. 4 illustrates an embodiment of a computer system for auditing digital targeted messages interacting with a digital targeted message.

FIG. 5 illustrates another embodiment of a computer system for auditing digital targeted messages interacting with a digital targeted message.

FIG. 6 illustrates a flowchart that depicts an embodiment of a method of auditing digital targeted messages.

FIG. 7 illustrates a flowchart that depicts another embodiment of a method of auditing digital targeted messages.

FIG. 8 illustrates a flowchart that depicts yet another embodiment of a method of auditing digital targeted messages.

### DETAILED DESCRIPTION

Embodiments described herein are directed to auditing dynamically created targeted digital messages. For example, disclosed embodiments are configurable to provide a variety of different user datasets to a targeted digital messaging system. The targeted digital messaging system then generates specific targeted digital messages based upon the received user datasets. Disclosed embodiments are capable of rendering the generated targeted digital messages and auditing the messages to ensure that they are properly constructed and properly targeted based upon the user data set that was sent to the targeted digital messaging system.

In various embodiments, communicating a user data set includes communicating a technical profile that describes a particular type of computer environment that is associated with a potential message recipient. Additionally, disclosed embodiments may communicate that technical profile by executing, within a hypervisor, the desired computing environment. For instance, it may be desirable to communicate a technical profile that is associated with a specific mobile phone operating system. In such an embodiment, the specific mobile phone operating system is executed within a hypervisor. The specific mobile phone operating system then communicates to the targeted digital messaging system a user data set that includes the technical profile. In response to receiving the user data, the targeted digital messaging system can generate a targeted digital message that is specific to the user dataset and the included mobile phone operating system.

In at least one embodiment, a system then audits the generated targeted digital message to ensure that it conforms with a desired message template. For example, the system may be configured to render the targeted digital message within the mobile phone operating system within the hypervisor. The system may then be configured to utilize the hypervisor to capture input/out streams within the mobile phone operating system. Once the rendered targeted digital message is captured, the system compares the rendered targeted digital message to a message template and determines whether any inconsistencies exist. A report is then generated that documents the results of the audit.

As such, disclosed embodiments provide solutions to problems that are unique to the internet. For instance, disclosed embodiments allow dynamically generated targeted digital messages to be audited on a per user and per platform basis. Additionally, disclosed embodiments provide increased accuracy for such auditing through the use of a hypervisor that runs a targeted operating system. Such a configuration provides an increase in technical accuracy because it is not necessary to generate a pseudo-technical profile that may not necessary reflect an actual executed operating system.

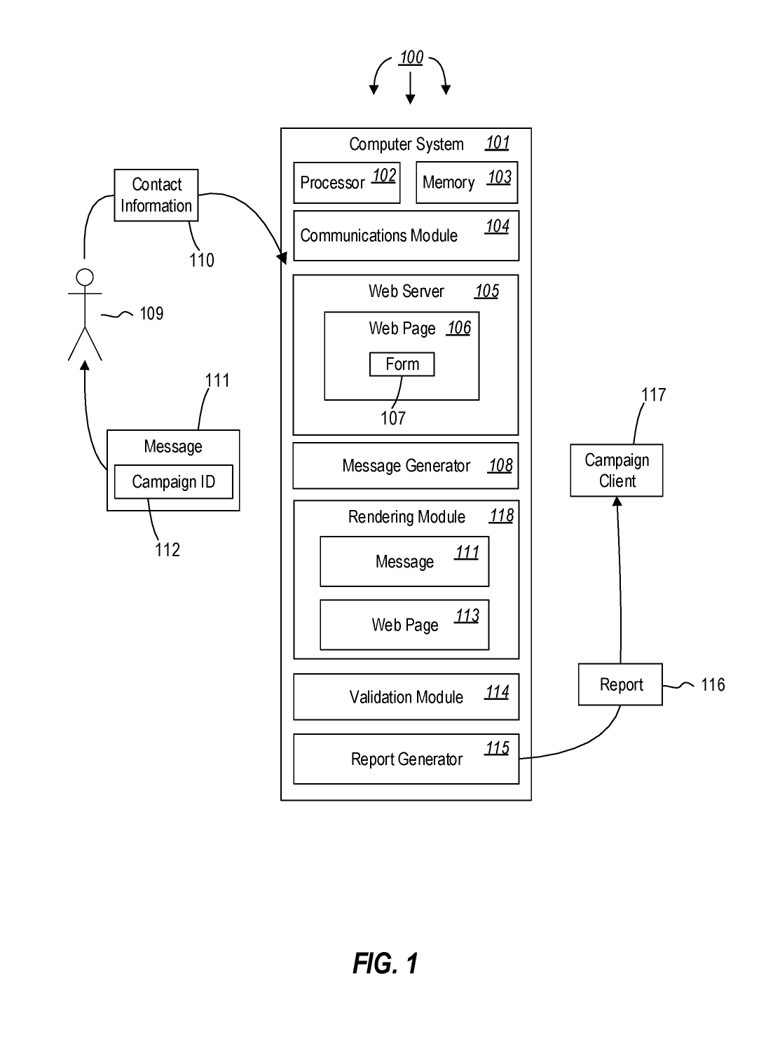

Referring now to the figures, FIG. 1 illustrates a computer architecture 100 in which at least one embodiment described herein may be employed. The computer architecture 100 includes a computer system 101. The computer system 101 includes at least one processor 102 and at least some system memory 103. The computer system 101 may be any type of local or distributed computer system, including a cloud computer system. The computer system 101 includes modules for performing a variety of different functions. For instance, communications module 104 may be configured to communicate with other computer systems. The communications module 104 may include any wired or wireless communication means that can receive and/or transmit data to or from other computer systems. The communications module 104 may be configured to interact with databases, mobile computing devices (such as mobile phones or tablets), embedded or other types of computer systems.

The computer system 101 may itself be a web server, or may be in communication with a web server, or may run a web server as a virtual machine within a hypervisor (as is depicted in FIG. 1). In any case, web server 105 may provide one or more web pages 106 with which users can interact and view content. For example, user 109 may interact with web page 106 via a web browser. The user may provide inputs including touch inputs on a mobile device or mouse and keyboard inputs on a desktop computer. The inputs may include providing contact information 110 to a given web page. For instance, web page 106 may have a form 107 or other means of requesting information from a user. The web page 106 may be part of a campaign that is requesting information from users who are or who may be interested in a given product or service.

As used herein, the term “campaign” refers to any type of marketing or advertising effort for a given product, service, or other item. The campaign may include web advertisements such as banners, pictures or overlays, email advertisements or notices, text messages, social media messages, photos, videos, in-application messages, or other content. Thus, in some embodiments, the web page 106 (or certain parts thereof) may be provided as part of a campaign for a given product or service. When the user 109 provides their contact information 110 (e.g. a phone number, an email address, a social media identity, account identifier etc.), the message generator 108 of computer system 101 may generate digital targeted message 111 and send it to the user 109.

The targeted digital message 111 may be a text message, an email, a social media message, an in-application message, or any other type of electronic message. In at least one embodiment, the digital targeted message 111 includes one or more of a campaign ID variable 112 that identifies the campaign, the user to whom the message is sent, the campaign originator or “campaign client” 117, and/or other entities. In some embodiments, the campaign ID variable 112 only identifies the campaign, such that any message or content with that identifier is definitively linked to the campaign.

The campaign client 117 may desire to know whether the digital targeted message 111 is being properly rendered when the user 109 views it. For instance, different messages may be sent to different types of users and/or different types of user devices. Accordingly, one demographic may receive one type of message, while another type of demographic receives another type of message for the same campaign. Similarly, each message may need to be pre-formatted to render properly on a particular type of device. The campaign client 117 may desire to know how each type of message that is sent out is ultimately rendered and presented to the user 109.

In at least one embodiment, a rendering module 118 is configured to render each type of digital targeted message 111 to determine whether the elements of the message are properly integrated and arranged. In at least one embodiment, the rendering module 118 comprises or is executed within a hypervisor. The hypervisor may comprise a particular-computer environment that matches the target of the message. For example, the hypervisor may execute a specific mobile device operating system. The rendering module 118 may then comprise a standard message rendering application within the particular-computer environment. For instance, the rendering module 118 may comprise a default web browser within the mobile device operating system. The rendering module 118 may be further configured to analyze the message that is rendered by the web browser (or other rendering engine) to audit it with respect to a message template.

In at least one embodiment, a validation module 114 (also referred to herein as the audit module 220) is configured to validate (also referred to herein as “audit”) each element of the message, as will be explained further below. Once the message has been validated, the report generator 115 of computer system 101 generates a report 116 and sends it to the campaign client 117. Thus, in this manner, the campaign client may be apprised of how each message is being rendered on the target client's devices and may thus have full control over how their campaign is presented to each client.

In at least one embodiment, reports are generated for content that is generated as part of a campaign. For example, the computer system 101 instantiates web page 106 on web server 105. The web page 106 includes various forms of web content including text, images, videos, games, applications or other content. The web content includes a form 107 that allows users to sign up to receive various types of messages. These messages may be, for example, buy-one-get-one-free offers, or other similar sales offers, or the messages may be reminders to do something, or notifications that something has occurred. The messages may include substantially any type of content that is related to a campaign.

In at least one embodiment, the computer system 101 initially receives contact information 110 from a user 109 via the form 107 on the web page 106. The user 109 may comprise a virtual user that is represented by a user dataset stored within a digital persona dataset. Each user dataset within the digital persona dataset represents a different virtual user that is associated with different characteristics. For example, a particular user dataset may represent a virtual user of a particular demographic, such as age, gender, income, address, and family status. Additionally, a user dataset may also comprise a technical profile that describes various attributes of the particular-computer environment.

In response to receiving the contact information 110, the message generator 108 generates a digital targeted message 111 that is to be sent to the user 109. The digital targeted message 111 includes a campaign variable 112 associated with the campaign. The rendering module 118 of computer system 101 then renders the generated digital targeted message 111 to validate anticipated characteristics of the message, and the report generator 115 generates a report 116 that illustrates the rendered message and provides one or more information points regarding the message.

The report 116 may thus include a representation of the digital targeted message 111 as it was rendered by the rendering module 118. Additionally or alternatively, the report may include information points such as indications of spelling errors, failed network requests, content that appeared in the wrong position or wrong orientation, content that was supposed to be targeted to other users, or other information requested by the campaign client 117. In at least one embodiment, the rendered message is compared to a message template.

As used herein, a message template comprises a digital description of an intended message content, format, and variables. For example, the message template may comprise information about the correct correlation of a campaign variable 112 to demographics of a recipient, message content, rendering instructions for particular computer environments, and other related information. The message template may also comprise various message parameters that are associated with a set of digital user attributes. For example, the message template may comprise specific parameters that are determined based upon the recipient's age, gender, and location. In at least one embodiment, the message template comprises a hypertext markup language data file that describes the desired targeted digital message.

While the digital targeted message 111 is being rendered, the validation module 114 may monitor which network requests were issued during or as a result of rendering the message. For instance, the message may include images, videos or other content that is hosted on different servers or web domains. The validation module 114 may ensure that these network requests are going to the proper server, web domain, directory or other specified location. If the messages are making improper or misdirected network requests, the campaign client 117 can be notified of such in the report 116.

If the digital targeted message 111 has web links to other web sites or web pages, the validation module 114 may follow the links to ensure they lead to a functioning web page, and that they are not routed to an improper (and potentially malicious) web site. The web link validation can be configured to search the linked website to a customizable depth. Thus, if desired, a thorough or a more superficial review of the linked site may be provided.

If images that are part of an email message, for example, are requested from a specific directory within a web server, those images may be accessed and rendered with the digital targeted message 111. The validation module 114 may keep track of each image and its corresponding location. This information may be reported in the report to the campaign client 117. If the campaign client has provided information indicating which directories the images are supposed to come from, the validation module 114 may perform a comparison to what was expected and what actually occurred when the message was rendered. If the two align, the report 116 may include an indication of such and, likewise, if the two are different, the report may indicate that the image location is not correct.

Other methods of verifying the images (or other content) may also be used. For instance, optical character recognition (OCR) may be used to verify the content in a message. If the computer system 101 is aware of what the message content is supposed to look like, from the perspective of an OCR analysis, the validation module 114 may compare the OCR analysis of the rendered digital targeted message 111 to the expected results. Again, if the two match or diverge, the report generator 115 may indicate such in the report 116. Thus, the campaign client 117 can be assured that the image they intended is actually loading in the campaign digital targeted message 111.

In some embodiments, the digital targeted message 111 is targeted, as part of the campaign, to persons in a specified demographic. For example, the digital targeted message 111 may be targeted to professionals in their 40s and 50s, or to teenagers, etc. Additionally or alternatively, the digital targeted message 111 may be targeted to persons having electronic devices that match a specified technology profile. For example, the message may be targeted to users that have a specified mobile device, or are using a specified web browser, or users that are on a desktop computer system. This may be referred to as a technology profile. Thus, the campaign client 117 may target their campaign to a specific demographic and/or to a specific technology profile.

When such messages are generated by the message generator 108, they may also be rendered by the rendering module 118. The rendering module may interact with a hypervisor to emulate a specific mobile device when rendering the digital targeted message 111 and may spoof a certain operating system or web browser on a desktop environment. Thus, the rendering module 118 may use emulation, spoofing or other technologies to simulate how the digital targeted message 111 would be rendered on a given device or using a given software application. In some cases, for example, the software application may be an email client. In such cases, the digital targeted message 111 (here an email) is rendered in the email client and is validated in the manner described above to ensure that the email content appears as expected and draws its content from the expected sources. Similarly, the email message may be rendered in a web browser. As such, the rendering module may render the email in the same way the web browser would.

The validation module 114 may also check the campaign variable 112 to verify that the digital targeted message 111 corresponds to the correct campaign. Any web links that are embedded in the digital targeted message 111 may also be validated to ensure that the link locations are correct. The validation module 114 may follow the links and render samples of the web pages that were linked. For instance, as shown in FIG. 1, the rendering module 118 may render web page 113, which is linked to the digital targeted message 111. The rendering module 118 may thus render this web page, and the validation module 114 may validate that the web page is rendered in an expected manner.

For instance, the validation module 114 may verify that images, text and video content are displayed properly, and that the campaign variable 112 stays with web content. Samples of these linked web pages may be included in the report 116 that is sent to the campaign client 117. Thus, in this manner, the campaign client may see a full circle of interaction, where a user provides contact information on a website, receives a campaign message, and follows a link from that message to another web page. Each stage in the user's interaction with the campaign may thus be verified and reported to ensure that the campaign is being carried out in the manner intended by the campaign client 117.

In some cases, proxy servers may be used to spoof a user's location. For example, if the campaign client 117 wanted to test whether messages sent to users in the Western half of the United States appeared different from those sent to users in the Eastern half, initial requests, including the providing of contact information 110, may be provided via proxy servers in those different locations. Then, when the user's requests and data are received, they will appear to be from those locations, and the message generator 108 will generate the corresponding location-appropriate message. Proxy servers may be used to approximate substantially any location, and make it appear as though the contact information 110 was received from a campaign target area.

Users' local storage, such as browser history, including cookie information, may be used to identify characteristics related to the users from whom contact information is received. For example, when the user 109 interacts with web page 106, the web server may access browser information and history data associated with the user. This information may be used by the web server to identify characteristics associated with the user, such as their demographics, preferences and shopping tendencies. The web browser may also provide hints as to the technology profile of the user, if such information is not otherwise available. Each of these types of information may be used to target messages to the user and may further be used to create a rendering environment that is as close to the targeted user's as possible.

The computer system 101 may also be configured to track subsequent actions of the user 109 on those websites that are linked to in the message. For example, the computer system 101 can track the user's interactions including web page requests to determine which products or services they end up purchasing. Thus, if a campaign client launches a campaign, the user receives a message and follows that message to a website (where they may receive a discount or other offer), the user's purchases on that website may also be tracked. In this manner, a campaign client may see the direct results of a targeted message. The reports generated by the reporting module 115 may report these findings to the campaign client 117.

Thus, in one example, a user may browse to a website they are curious about. The user may select the form 107 and provide contact information such as a phone number or email address. The message generator 108 may gather any information available about the user and generate a message that is targeted specifically for that user. The message (e.g. a text message) may then be sent to the user's mobile device. The user may then view the message and, if the message has links, may follow the links to another website where a discounted product or service may be purchased. At each step, the rendering module 118 may render the messages and websites that are generated, and the validation module 114 may validate the rendered messages and websites to ensure that the content is provided as expected. Network requests, images, content and other parameters may be checked to ensure the campaign messages and websites are being rendered as expected. Detailed reports regarding the outcome of these renderings and validations may be sent to the campaign client for analysis.

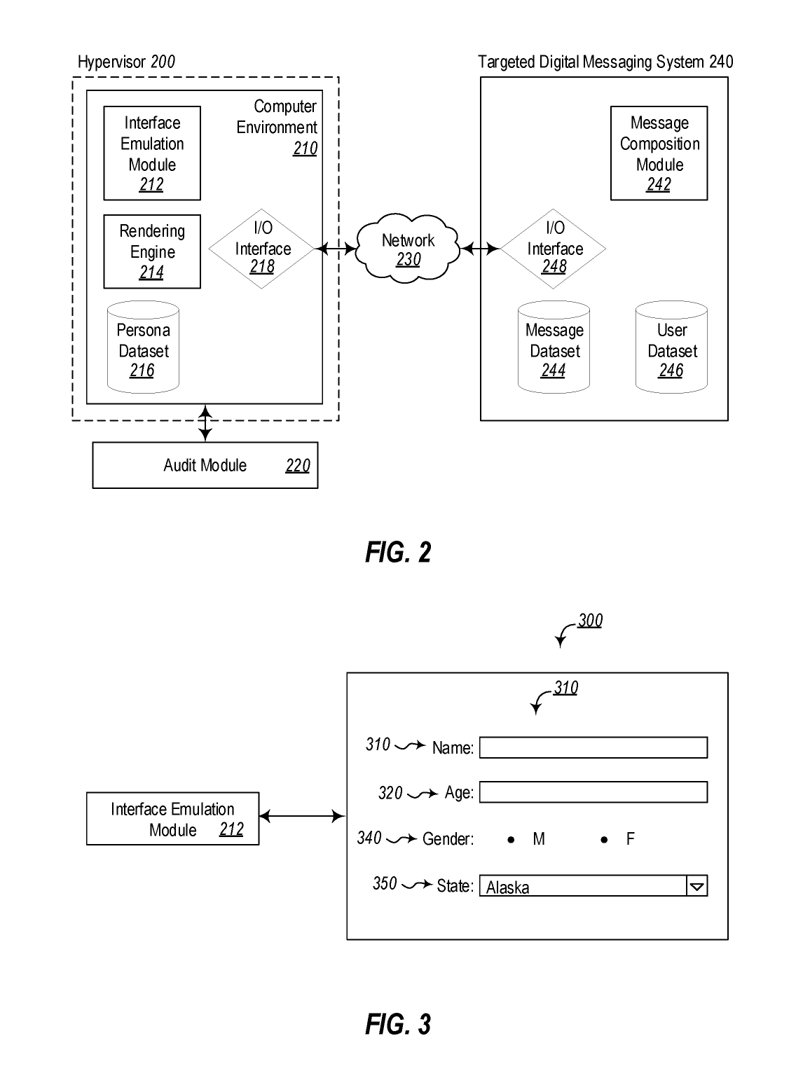

FIG. 2 illustrates another embodiment of a computer system for auditing digital targeted messages 111. As depicted in FIG. 2, the computer system can initiate a network-connected hypervisor 200 that is executing a particular-computer environment 210. For example, the hypervisor 200 may be executed within an operating system on a server. The particular-computer environment 210 may comprise a particular desktop operating system, particular mobile phone operating system, or any other target operating system. The network-connected hypervisor 200 may be in digital communication with a targeted digital messaging system 240 that is located external to the hypervisor 210.

The particular-computer environment 210 may comprise an interface emulation module 212. In at least one embodiment, the interface emulation module 212 is configured to emulate, within the particular-computer environment 210, an interface for interfacing with the targeted digital messaging system 240. For example, the target digital messaging system 240 may request user information through a webpage interface. In such an embodiment, the interface emulation module 212 comprises a web browser executed within the particular-computer environment 210. The interface emulation module 212 causes the user interface to be rendered. Information from a user dataset can then be entered into the user interface. In at least one embodiment, the information from the user dataset is automatically entered through the user interface. As such, the user interface can also be audited.

In at least one embodiment, the network-connected hypervisor 200 communicates a user data set to the targeted digital messaging system 240. The user dataset is selected from the digital persona dataset 216 that is stored within the particular-computer environment 210. In at least one embodiment, the digital persona dataset 216 is stored within network-accessible local storage in the particular-computer environment 210. For example, the digital persona dataset may be stored within a cookie or within other local storage that is network-accessible. Additionally, in at least one embodiment, the digital persona dataset 216 comprises user datasets for multiple different users. As such, the digital persona dataset 216 can load different user datasets into the targeted digital message system 240 in order to verify that the digital message system 240 properly adjusts the resulting targeted digital messages 111 based upon the received user dataset.

The user dataset comprises one or more variables associated with a particular class of users. For example, the user dataset may comprise demographic information describing a virtual user. The demographic information may comprise digital user attributes such as age, race, gender, income, and geographic location. Additionally, the user dataset may comprise a digital indicator of one or more hyper-text links that were previously traversed. The user dataset may also comprise a technical profile that describes various attributes of the virtual user's computer environment. For example, the technical profile may comprise an indication of the user's operating system.

In response to the targeted digital messaging system 240 receiving the one or more variables from the user dataset, a message composition module 242 within the targeted digital messaging system 240 generates a message based upon the one or more variables. For example, the message composition module 242 may access information message characteristics stored within the message dataset 244. Particular message characteristics may be associated with one or more variables from a user dataset. For example, a message characteristic may comprise a particular campaign variable, a particular multimedia file, a particular sale offer, or any other unique message attribute. Using the message characteristics stored within the message dataset 244, the targeted digital messaging system 240 generates a targeted digital message 111.

Additionally, in at least one embodiment, the message composition module 242 also accesses information within a user dataset 246. The user dataset 246 comprises information about various users who have previously interacted within the targeted digital messaging system 240 or an otherwise affiliate system. For instance, a particular user may have a user account and a long history of interests stored within the user dataset 246. As such, the message composition module 242 is able to rely upon information from a dataset received from the particular computer environment 210 and user dataset information 246 that was previously captured.

Once the targeted digital message 111 has been created, the particular-computer environment 210 receives the targeted digital message 111. Using the render engine 214, the particular-computer environment then renders the targeted digital message 111 generated by the targeted digital messaging system 240. As used herein, the render engine 240 may comprise a software application that is executed externally to the hypervisor, a software application that is executed within to the hypervisor and external to the particular-computer environment 210, or within the particular-computer environment. In at least one embodiment, the render engine 214 comprises an application that is executed within the particular-computer environment 210 such as a web browser, an email application, a messaging application, or any other executable application.

In at least one embodiment, rendering the targeted digital message 111 comprises rendering message attributes that are responsive to the one or more variables within the user dataset. For example, the targeted digital message 111 may comprise unique attributes that are responsive to the one or more variables within the user dataset. The unique attributes may comprise the receiver's name, specific multimedia content based upon the one or more variables within the user dataset, and/or other similar characteristics.

Once the targeted digital message 111 is rendered, the audit module 220 audits the message attributes against a message template. As depicted, the audit module 220 may be executed external to the hypervisor. In additional or alternative embodiments, however, the audit module 220 may be executed within the hypervisor and/or within the particular-computer environment.

Auditing the targeted digital message 111 against the message template can comprise processing the one or more variables from the user dataset with the message template. The resulting message template can then be compared to the targeted digital message 111. The comparison can comprise a visual comparison using an optical analysis program, parsing digital content within the targeted digital message 111 for comparison to the message template, and/or a source code comparison program. In additional or alternative embodiments, the auditing can comprise comparing a list of attributes described by the message template with the targeted digital message 111.

As an example of an audit function, the message template may describe a particular link from which a picture should be presented within the targeted digital message. The audit module 220 can determine whether the correct link and picture are present within the targeted digital message 111. As an additional example, the targeted digital message may comprise an unrendered digital campaign variable 112 (also referred to herein as “campaign variable”). For instance, the digital campaign variable 112 may be present within the header of an email. The audit module 220 can parse the digital campaign variable 112 from the source code of the message. The audit module 220 can then compare the digital campaign variable 112 in the digital targeted message to a desired digital campaign variable as indicated in the message template. In at least one embodiment, the audit module 220 audits the digital campaign variable 112 by matching the digital campaign variable 112 to a set of message parameters within the message template. For instance, specific digital campaign variables 112 may be associated with specific digital content within a desired digital targeted message.

The audit module 220 also generates a report indicating at least a portion of the differences between the message attributes and the message template. The report may display various visual depictions of the targeted digital message 111 and/or the message template. The report may also display incorrect portions of the targeted digital message and/or the one or more variables within the user dataset that did not properly influence the targeted digital message 111.

One will appreciate that the above steps can be repeated for different user datasets that represent different users. As such, a resulting report can comprise an audit of a large number of messages that were generated based upon input data from different user datasets.

FIG. 3 illustrates an embodiment of a computer system for auditing digital targeted messages interacting with a user interface 300. As mentioned above, in at least one embodiment, the interface emulation module 212 is configured to cause a user interface to be rendered. Additionally or alternatively, the interface emulation module 212 is configured to interact with a rendered user interface. For example, the interface emulation module 212 may be configured to enter data from a user dataset into the user interface.

In the depicted embodiment, the interface emulation module 212 enters a virtual user's name 310, age 320, gender 340, and state 350. The information is then communicated to a targeted digital messaging system 240. A resulting targeted digital message 111 may comprise characteristics that are directly responsive to the virtual user's name 310, age 320, gender 340, and state 350.

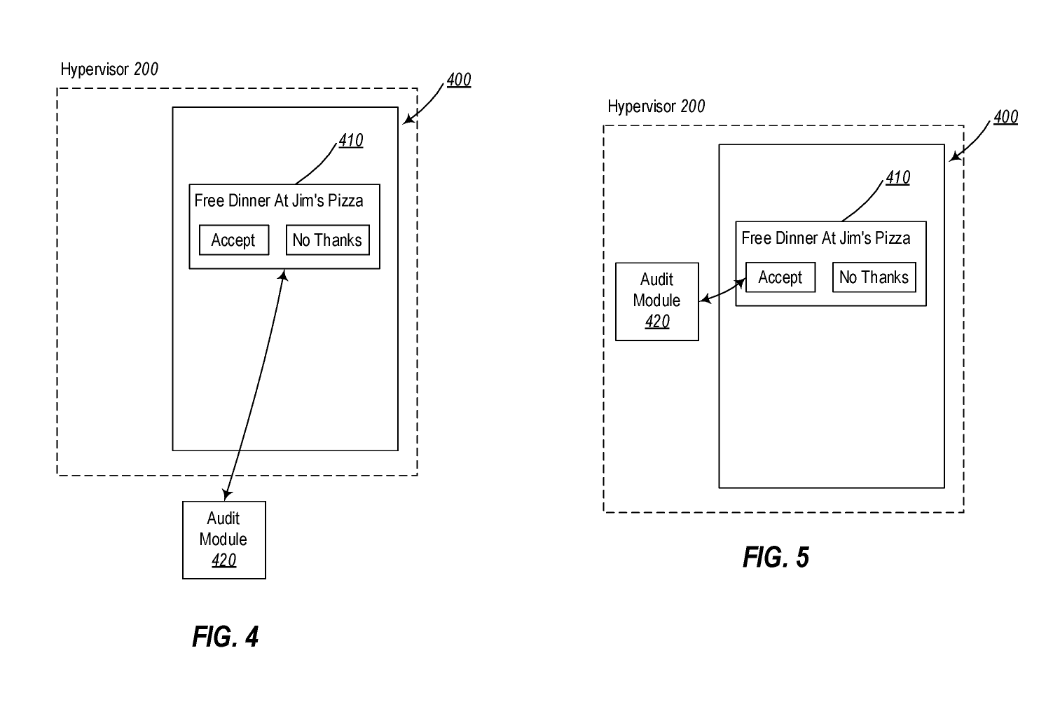

FIG. 4 illustrates an embodiment of a computer system for auditing digital targeted messages interacting with a digital targeted message. For example, FIG. 4 illustrates a hypervisor 200 running a particular application 400. The application may comprise a web browser, an email program, a messaging program, a game, a word processing program, or any other executable program. The digital targeted message 410 is displayed within the particular application 400 in the hypervisor 200. In the depicted embodiment, the targeted digital message 410 comprises an advertisement for pizza. The targeted digital message 410 also include interactive features that include an “Accept” button and a “No Thanks” button. In at least one embodiment, selecting either button will cause the user to redirect to a hyperlinked website.

In at least one embodiment, the audit module 420 is configured to audit the targeted digital message 410. The audit module 420 may be configured to parse the targeted digital message 410, access the source code of the targeted digital message 410, or otherwise compare the targeted digital message 410 to a message template. In at least one embodiment, the audit module 420 selects every selectable link associated with the targeted digital message 410 and determines whether the link properly loads and whether the link loads the correct content as determined by the received user dataset.

FIG. 5 illustrates another embodiment of a computer system for auditing digital targeted messages interacting with a digital targeted message 410. In FIG. 5, in contrast to FIG. 4, the audit module 420 is executed within the hypervisor 200. Such a configuration may provide the benefit that the audit module 420 is executed within the same particular-computer environment as the digital targeted message 410.

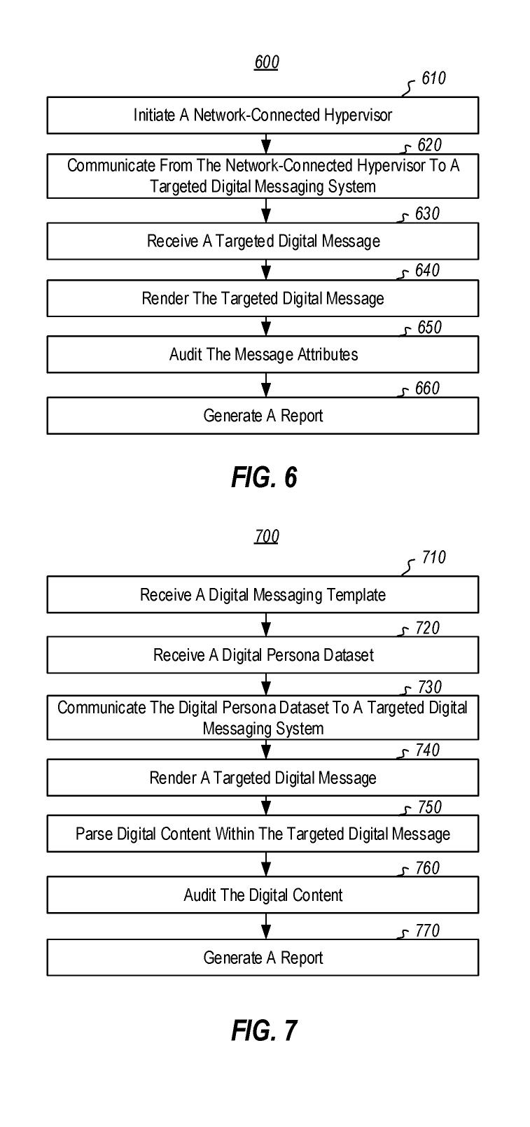

One will appreciate that disclosed invention can also be described in terms of methods comprising one or more acts for accomplishing a particular result. For example, FIGS. 6-8 and the corresponding text illustrate flowcharts of a sequence of acts in a method for auditing digital targeted messages. The acts of FIGS. 6-8 are described below with reference to the components and modules illustrated in FIGS. 1-5.

For instance, FIG. 6 illustrates that method 600 for auditing digital targeted messages comprises an act 610 of initiating a network-connected hypervisor. Act 610 includes initiating a network-connected hypervisor that is executing a particular-computer environment. The network-connected hypervisor is in digital communication with a targeted digital messaging system that is located external to the hypervisor. The particular-computer environment is storing a digital persona dataset. For example, as depicted and described with respect to FIG. 2, a hypervisor 200 executes a particular-computer environment 210. The hypervisor 200 communicates with the targeted digital messaging system 240 through network 218. Additionally, as depicted the particular-computer environment 210 comprises a persona dataset 216.

Additionally, FIG. 6 illustrates that method 600 comprises an act 620 of communicating from the network-connected hypervisor to a targeted digital messaging system. Act 620 includes communicating from the network-connected hypervisor to the targeted digital messaging system a first user dataset that is selected from the digital persona dataset. The first user dataset comprises one or more variables associated with a particular class of users. For example, as depicted and described with respect to FIG. 2, the hypervisor 200 communicates with the targeted digital messaging system 240 through a I/O interface 230 that communicates through network 218 to an I/O interface 248 within the targeted digital messaging system 240. Additionally, as depicted the particular-computer environment 210 comprises a persona dataset 216.

FIG. 6 also illustrates that method 600 comprises an act 630 of receiving a targeted digital message. Act 630 includes in response to the targeted digital messaging system receiving the one or more variables, receive a targeted digital message. For example, as depicted and described with respect to FIGS. 2 and 3, the targeted digital messaging system uses the message composition module 242 to generate a targeted digital message that is responsive to the received user dataset.

FIG. 6 additionally illustrates that method 600 comprises an act 640 of rendering the targeted digital message. Act 640 includes rendering, within the particular-computer environment, the targeted digital message generated by the targeted digital messaging system, wherein rendering the targeted digital message comprises rendering message attributes that are responsive to the one or more variables within the first user dataset. For example, as depicted and described with respect to FIGS. 2, 4, and 5, a rendering engine 214 within the hypervisor 200 renders the targeted digital message. The rendering engine 214 may comprise a program executed within the particular-computer environment 210, such as a web browser.

Further, FIG. 6 illustrates that the method 600 comprises an act 650 of auditing the message attributes. Act 650 includes auditing the message attributes against a message template. For example, as depicted and described with respect to FIGS. 2, 4, and 5, an auditing module 220 audits the rendered message with respect to a message template.

Further still, FIG. 6 illustrates that the method 600 comprises an act 660 of generating a report. Act 660 includes generating a report indicating at least a portion of the differences between the message attributes and the message template. For example, as depicted and described with respect to FIGS. 1 and 2 a report generator 115 can generate a report describing the various deficiencies in the targeted digital message with respect to the message template.

For instance, FIG. 7 illustrates that method 700 for auditing digital targeted messages comprises an act 710 of receiving a digital messaging template. Act 710 includes receiving a first digital message template that comprises a first set of message parameters associated with a set of digital user attributes. For example, as depicted and described with respect to FIGS. 1 and 2, the audit module 220 receives a digital messaging template (also referred to herein as “message template”).

Additionally, FIG. 7 illustrates that method 700 comprises an act 720 of receiving a digital persona dataset. Act 720 includes receiving a digital persona dataset, wherein the digital persona dataset comprises a first user dataset. For example, as depicted and described with respect to FIG. 2, the hypervisor 200 comprises a persona dataset 216 that stores various different user dataset. The persona dataset 216 can be loaded prior to auditing a particular targeted digital messaging system 240. As such, the persona dataset 216 can be loaded with particular user datasets that are selected to audit desired features of the particular targeted digital messaging system 240.

FIG. 7 also illustrates that method 700 comprises an act 730 of communicating the digital persona dataset to a targeted digital messaging system 730. Act 730 includes communicating the first user dataset to a targeted digital messaging system. For example, as depicted and described with respect to FIGS. 2 and 3, the interface emulation module 212 is able to automatically enter user dataset information into a user interface that communicates to the targeted digital messaging system 200.

FIG. 7 additionally illustrates that method 700 comprises an act 740 of rendering the targeted digital message. Act 640 includes rendering a first targeted digital message generated by the targeted digital messaging system, wherein rendering the first targeted digital message comprises rendering first message attributes that are responsive to variables within the first user dataset. For example, as depicted and described with respect to FIGS. 2, 4, and 5, a rendering engine 214 within the hypervisor 200 renders the targeted digital message. The rendering engine 214 may comprise a program executed within the particular-computer environment 210, such as a web browser.

FIG. 7 also illustrates that the method 700 comprises an act 750 of parsing digital content within the targeted digital message 750. Act 750 includes parsing first message attributes within the first targeted digital message. For example, as depicted and described with respect to FIGS. 2, 4, and 5, an auditing module 220 is able to parse message characteristics out of a targeted digital message.

Further, FIG. 7 illustrates that the method 700 comprises an act 760 of auditing the message attributes. Act 760 includes auditing the first message attributes against the first set of message parameters within the first digital message template, wherein auditing the first message attributes comprises identifying differences between the first message attributes and the first set of message parameters. For example, as depicted and described with respect to FIGS. 2, 4, and 5, an auditing module 220 audits the rendered message with respect to a message template. The auditing module 220 is configured to identify difference between the message template and the rendered targeted digital message.

Further still, FIG. 7 illustrates that the method 700 comprises an act 770 of generating a report. Act 770 includes generating a report indicating at least a portion of the differences between the first message attributes and the first set of message parameters. For example, as depicted and described with respect to FIGS. 1 and 2 a report generator 115 can generate a report describing the various deficiencies in the targeted digital message with respect to the message template.

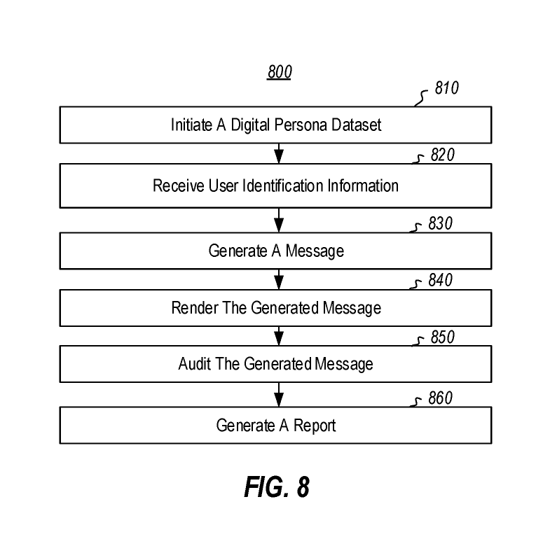

Turning now to FIG. 8, FIG. 8 illustrates a flowchart that depicts yet another embodiment of a method of auditing digital targeted messages. FIG. 8 illustrates that method 800 for auditing digital targeted messages comprises an act 810 of initiating a digital persona dataset. Act 810 includes initiating a digital persona dataset to interact with web content, wherein the digital persona dataset is associated with a user identification. For example, as depicted and described with respect to FIG. 2, a hypervisor 200 executes a particular-computer environment 210. The hypervisor 200 is associated with a persona dataset 216. The persona dataset 216 may be custom created for a particular audit process. The persona dataset 216 comprises user dataset that describe particular virtual users of interest.

Additionally, FIG. 8 illustrates that method 800 comprises an act 820 of receiving user identification information. Act 820 includes receiving user identification information from the digital persona dataset. For example, as depicted and described with respect to FIGS. 2 and 3, the interface emulation module 212 can receive user identification information from the persona dataset 216 and enter the identification information into a user interface 300.

FIG. 8 also illustrates that method 800 comprises an act 830 of generating a targeted digital message. Act 830 includes in response to receiving the user identification information, generating a message that is to be sent as part of the digital media campaign, the message including a campaign variable associated with the campaign. For example, as depicted and described with respect to FIGS. 2 and 3, the targeted digital messaging system uses the message composition module 242 to generate a targeted digital message that is responsive to the received user dataset.

FIG. 8 additionally illustrates that method 800 comprises an act 840 of rendering the targeted digital message. Act 840 includes rendering the generated message. For example, as depicted and described with respect to FIGS. 2, 4, and 5, a rendering engine 214 within the hypervisor 200 renders the targeted digital message. The rendering engine 214 may comprise a program executed within the particular-computer environment 210, such as a web browser.

Further, FIG. 8 illustrates that the method 800 comprises an act 850 of auditing the generated message. Act 850 includes auditing one or more anticipated characteristics of the message with the digital persona dataset. For example, as depicted and described with respect to FIGS. 2, 4, and 5, an auditing module 220 audits the rendered message with respect to a message template.

Further still, FIG. 8 illustrates that the method 800 comprises an act 860 of generating a report. Act 860 includes generating a report that illustrates the rendered message. For example, as depicted and described with respect to FIGS. 1 and 2 a report generator 115 can generate a report illustrating the targeted digital message and describing the various deficiencies in the targeted digital message with respect to the message template.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. The present invention can also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the present invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment may comprise a system that includes one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described preset invention is to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer system for auditing a targeted digital messaging system, the computer system comprising:
one or more processors; and
one or more computer-storage media having stored thereon executable instructions that when executed by the one or more processors configure the computer system to perform at least the following:
initiate a network-connected hypervisor that is executing a particular-computer environment, wherein:
the network-connected hypervisor is in digital communication with a targeted digital messaging system that is located external to the hypervisor, and
the particular-computer environment is storing a digital persona dataset;
communicate from the network-connected hypervisor to the targeted digital messaging system a first user dataset that is selected from the digital persona dataset, wherein the first user dataset comprises:
one or more variables associated with a particular class of users;
in response to the targeted digital messaging system receiving the one or more variables, receive a targeted digital message;
render, within the particular-computer environment, the targeted digital message generated by the targeted digital messaging system, wherein rendering the targeted digital message comprises rendering message attributes that are responsive to the one or more variables within the first user dataset;
audit the message attributes against a message template; and
generate a report indicating at least a portion of the differences between the message attributes and the message template.

2. The computer system as recited in claim 1, wherein the digital persona dataset is stored within network-accessible local storage in the particular-computer environment.

3. The computer system as recited in claim 2, wherein the digital persona dataset is stored within a browser-based cookie.

4. The computer system as recited in claim 1, wherein the first user dataset further comprises a technical profile that describes various attributes of the particular-computer environment.

5. The computer system as recited in claim 4, wherein the technical profile comprises an indication of the operating system within the particular-computer environment.

6. The computer system as recited in claim 1, wherein the one or more variables associated with a particular class of users comprise:
a digital indicator of an age,
a digital indicator of a gender, and
a digital indicator of one or more hyper-text links that were previously traversed.

7. The computer system as recited in claim 1, wherein the targeted digital message comprises an email.

8. The computer system as recited in claim 1, wherein the targeted digital message comprises an in-application message that appears within an application executed within the particular-computer environment.

9. A method, implemented at a computer system that includes at least one processor, for auditing a targeted digital messaging system, the method comprising:
receiving a first digital message template that comprises a first set of message parameters associated with a set of digital user attributes;
receiving a digital persona dataset, wherein the digital persona dataset comprises a first user dataset;
communicating the first user dataset to a targeted digital messaging system;
rendering a first targeted digital message generated by the targeted digital messaging system, wherein rendering the first targeted digital message comprises rendering first message attributes that are responsive to variables within the first user dataset;
parsing first message attributes within the first targeted digital message;
auditing the first message attributes against the first set of message parameters within the first digital message template, wherein auditing the first message attributes comprises:
identifying differences between the first message attributes and the first set of message parameters; and
generating a first report indicating at least a portion of the differences between the first message attributes and the first set of message parameters.

10. The method as recited in claim 9, wherein the digital persona dataset comprises a second user dataset that is different than the first user dataset.

11. The method as recited in claim 10, further comprising:
receiving a second digital message template that comprises a second set of message parameters;
receiving the digital persona dataset, wherein the digital persona dataset comprises the second user dataset;
rendering a second targeted digital message, wherein rendering the second targeted digital message comprises rendering second message attributes that are responsive to variables within the second user dataset;
auditing the second message attributes against the second set of message parameters within the second digital message template; and
generating a second report indicating at least a portion of the differences between the second message attributes and the second set of message parameters.

12. The method as recited in claim 9, wherein an unrendered portion of the first targeted digital message comprises a digital campaign variable.

13. The method as recited in claim 12, wherein the digital campaign variable comprises a user identification that is associated with a particular user.

14. The method as recited in claim 13, further comprising auditing the first message attributes against the first set of message parameters within the first digital message template by matching the digital campaign variable to the first set of message parameters.

15. The method as recited in claim 9, wherein the first digital message template comprises a hypertext markup language data file.

16. The method as recited in claim 9, wherein the first targeted digital message attributes are different than the second targeted digital message attributes.

17. A method, implemented at a computer system that includes at least one processor, for reporting on content generated as part of a digital media campaign, the method comprising:
initiating a digital persona dataset to interact with web content, wherein the digital persona dataset is associated with a user identification;
receiving user identification information from the digital persona dataset;
in response to receiving the user identification information, generating a message that is to be sent as part of the digital media campaign, the message including a campaign variable associated with the campaign;
rendering the generated message;
auditing one or more anticipated characteristics of the message with the digital persona dataset; and
generating a report that illustrates the rendered message.

18. The method of claim 17, wherein the report further includes an indication of which network requests were issued as a result of rendering the message.

19. The method of claim 17, wherein receiving user identification information from the digital persona dataset comprises receiving the user identification information from a local storage of a computing device.

20. The method of claim 17, wherein auditing one or more anticipated characteristics of the message with the digital persona dataset comprises auditing information within an email header against information within the digital persona dataset.
